(19) United States
(12) Patent Application Publication
(10) Pub. No.: US 2017/0242780 A1
(43) Pub. Date: Aug. 24, 2017

(54) Graphical Sequence Builder

(71) Applicant: Vtool Ltd., Benei Brak (IL)

(72) Inventor: Hagai Arbel, Tel Aviv (IL)

(21) Appl. No.: 15/426,166

(22) Filed: Feb. 7, 2017

Related U.S. Application Data
(60) Provisional application No. 62/292,605, filed on Feb. 8, 2016.

(51) Int. Cl. G06F 11/36; G06F 3/0482; G06F 3/0484; G06F 3/0486

(52) U.S. Cl. CPC G06F 11/3664; G06F 3/0486; G06F 3/0482; G06F 3/04847; G06F 11/3684

(57) ABSTRACT

A graphical tool generates test scenarios to be simulated on an integrated circuit. The tool provides for the assembly of a graphical flow chart that represents source code associated with test scenarios, which helps alleviate the need for manual coding and de-bugging.

### RELATED APPLICATIONS

This application claims priority to U.S. provisional application No. 62/292,605, filed on Feb. 8, 2016, titled “Graphical Sequence Builder,” which is hereby incorporated by reference in its entirety.

### BACKGROUND

Designing integrated circuits often involves consideration of various factors that relate to electronics, circuits, analog functions, logic, and other functionality. Before an integrated circuit device is released for production, the device may undergo a series of simulation tests to ensure that it will operate as planned and expected. These simulation tests are referred to as design verification. Design verification emulates bugs and other issues that may occur in a device, so that the design team can remedy mistakes before they reach the end customer.

Verification often involves several engineers collaborating in a combined effort to check and test multiple circuits under various circumstances and operating environments. The standardized protocol Universal Verification Methodology (UVM) is a common framework that allows for unified verification techniques for integrated circuits, streamlining the verification process. However, UVM still requires laborious manual coding and de-bugging, both of which are time consuming and labor intensive. Such efforts are also prone to manual errors, as users manually process, navigate, and try to clearly understand large amounts of data.

### SUMMARY

The present disclosure describes a computer and/ or computer processor configured to generate test code based on a graphical representation of a test scenario. The graphical test scenario sequence simulates testing on an integrated circuit device. The processor is in communication with a user interface and a memory (e.g., an electronic storage device such as a hard drive or a memory chip). The computer processor is configured to execute a variety of programs, which may collectively be referred to as a graphical sequence builder.

The programs execute (e.g., the programs are processed or run by the processor) to generate test code based on a graphical representation of a test scenario. The programs include a building program that builds a flow chart for display on a user interface (e.g., an interface display on a computer monitor), with graphical event modules representing source code of test scenarios. A flow control program displays graphical flow control operators representing source code associated with logical elements connecting graphical event modules in the flow chart. The code generating program can merge the source code associated with the graphic event modules and the graphical flow control operators to preserve the sequence or “flow” of the source code represented graphically in the flow chart. A user can rearrange modules by dragging and dropping them within the flow chart, and the code generating program will generate new source code to represent the re-assembled sequence.

A navigation program allows a user to interact with the user interface. The navigation program executes to operate functionality, which functionality can include expanding display windows, toggling between windows, zooming in and out of the flow chart, panning, manually inputting commands in a command terminal, selecting event and flow logic modules, and dragging and dropping graphical event modules. Upon assembly of the flow chart, the graphical test scenario source code is written to a file, saved and outputted to the end user.

The implementation of graphics representing source code alleviates laborious manual coding and de-bugging, which are time consuming and labor intensive. The graphical sequence builder also mitigates manual errors, since it alleviates the need for a user to process, navigate, and clearly understand large amounts of data.

These and other benefits may become clearer upon making a thorough review and study of the following detailed description.

### BRIEF DESCRIPTION OF THE DRAWINGS

FIG. 1 is a block diagram of an example computing system configured to operate the graphical sequence builder programs described herein.

FIG. 2 is a block diagram showing program modules executed by a computer processor in accordance with at least one embodiment of the present disclosure.

FIG. 3 is a block diagram showing the interaction of a navigation program with a user interface in accordance with at least one embodiment of the present disclosure.

FIG. 4 is an example screenshot of an interface operating a graphical sequence builder displaying a hybrid view.

FIG. 5 shows an example screenshot of an interface operating a graphical sequence builder displaying a graphical flow chart with a start node and an end node.

FIG. 6 shows an example screenshot of an interface operating a graphical sequence builder displaying a graphical flow chart with a drop-down menu of flow controls and action blocks.

FIG. 7 shows an example screenshot of an interface operating a graphical sequence builder displaying a graphical flow chart with graphical event modules and graphical flow control modules.

FIG. 8 shows an example screenshot of an interface operating a graphical sequence builder displaying a graphical flow chart with a case node.

FIG. 9 shows an example screenshot of an interface operating a graphical sequence builder displaying a graphical flow chart with a While Loop graphical event module.

FIG. 10 shows an example screenshot of an interface operating a graphical sequence builder displaying a graphical flow chart with a custom code block graphical event module.

FIG. 11 is a flow diagram of a method for operating a graphical sequence builder in accordance with the embodiments described herein.

### DETAILED DESCRIPTION

The present disclosure describes examples of computer implementable techniques or programs that allow efficient and convenient production of test scenarios when compared to manual coding techniques. These programs may be referred to collectively as a “graphical sequence builder,” or a “graphical sequence builder.” Certain embodiments of the graphical sequence builder can create virtual test simulations in a graphical environment to be simulated on an integrated circuit.

The graphical sequence builder includes programs that add graphical test modules to a graphical environment via a user interface, and assemble a graphical test scenario in the form of a flow chart. Using these programs a user can add or delete graphical modules to the graphical flow chart to manipulate from a user interface to manipulate the test scenario without needing to rely on manual coding. For example, a user add graphical modules by way of a drop-down or other type of list or menu, via a drag and drop feature, via keyboard shortcuts, or via other techniques that do not necessarily involve manual coding. The graphical sequence builder also includes programs that add flow control operators (or flow control modules) that dictate or otherwise regulate the flow the test sequence among the graphical test modules in the flow chart. For example, the flow control operators inform the flow chart which test modules should precede and/or follow another in the test sequence, and can also indicate whether certain logic conditions apply to the sequence.

Certain aspects of the graphical sequence builder also include a navigation program that provides a graphical interface that facilitates navigation among various components of the graphical sequence builder (e.g., the graphical environment, the source code, the command line terminal, etc.). The navigation program allows the user to display and edit existing components at various levels, and in various formats (e.g., graphical format, source code format, hybrid formats, etc.).

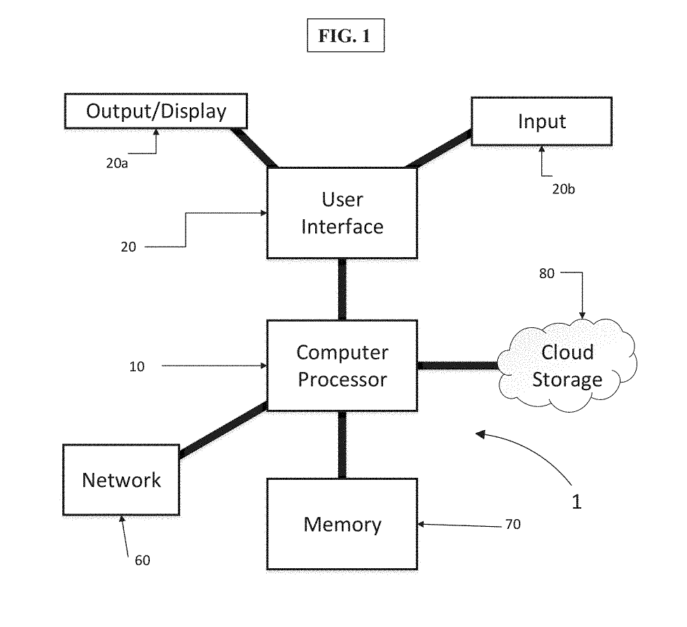

The drawings present block diagrams, flow diagrams, screen shots and other graphics depicting implantation and operation of various examples of the graphical sequence builder and related components. FIG. 1 is a block diagram showing a computing system 1 that can be used to implement programs associated with the presently described graphical sequence builder. The computing system 1 comprises a computer processor (CPU) 10, which interacts with a user interface 20. The user interface 20 can include an input device 20b and an output device, e.g. a display 20a. The display 20a can be, or can include, one or more of a monitor, printer, touch screen, audio device, or other computer-related devices that present output generated by the computing system 1. The input device 20b can be, or can include, one or more of a mouse, a touch screen, a keyboard, a microphone, a touch pad, or other computer-related devices that allow a user to interact with a computer and provide feedback. In essence, the user interface 20 allows a user to interact with the computing system 1, and provides relevant information that the computer generates to the user.

In some embodiments, the input device 20b and the display 20a can be the same, or at least intertwined. For example, the user interface 20 can include a touch screen that provides both the function of the display 20a and the input device 20b.

The CPU 10 also comprises and/or accesses memory 70, which can be an electronic storage device. For example, the memory 70 can include a thumb drive, an SD card (or micro SD card), RAM memory, a hard drive, or other storage media, or a combination of such memory. The memory 70 can also be stored on the cloud 80, for example, and in some embodiments can include or be in communication with a network 60 or some other device that allows information stored on the memory 70 to communicate with the CPU 10, and the user interface 20.

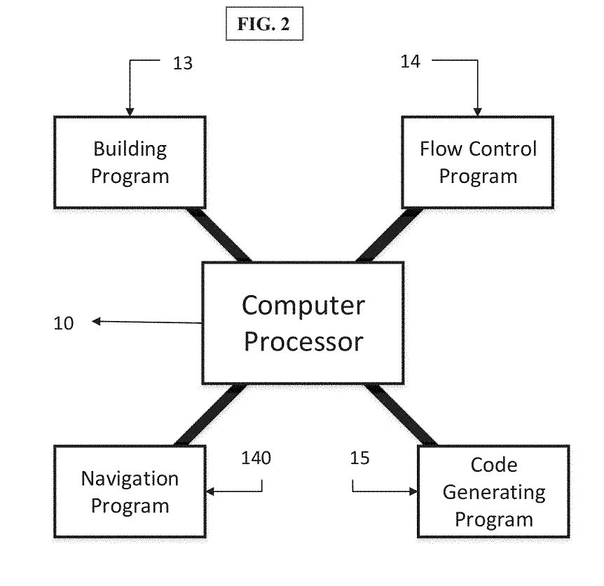

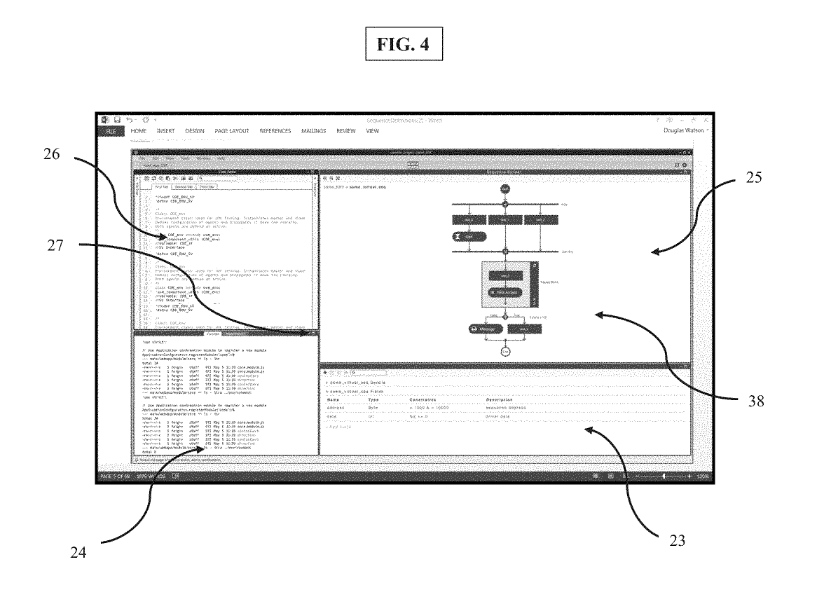

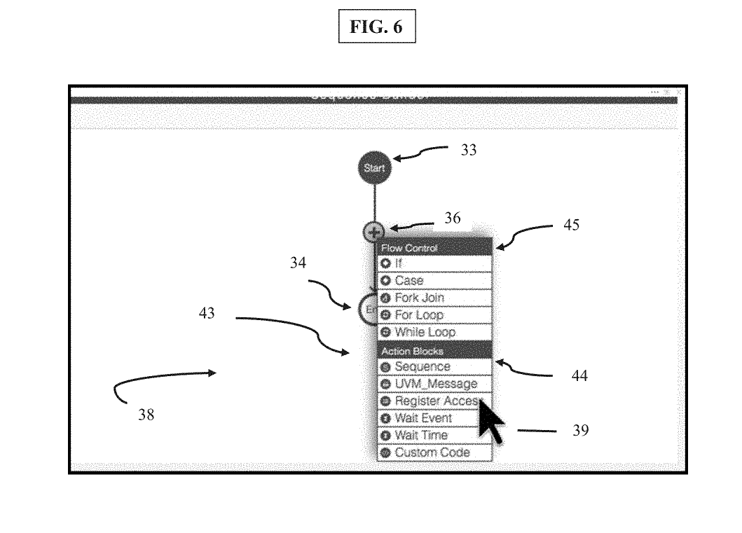

FIG. 2 is a block diagram example of various programs of the graphical sequence builder that may be executed by the CPU 10. Among the programs included are a building program 13 that builds a flow chart 38 (see FIG. 4) by accessing an array of event modules from the computer memory 70. Each of the event modules is associated with its own source code that executes to simulate a particular test event as part of the test scenario. In response to receiving an “add event” signal from the user interface 20, the building program 13 displays, in a graphical environment, a graphical event module in the flow chart, wherein each event module graphic is associated with an event module from the array. For example, a user can click on an action block 44 of a drop-down menu 43 (shown in FIG. 6) with a mouse cursor arrow icon 39 on the user interface 20 to generate an add event signal.

In one example, one program (e.g., the building program 13) or a combination of the programs operate within the UVM framework; a standardized protocol designed to help unify techniques for verifying integrated circuit designs. The UVM provides a library of automation features that are compatible with the System Verilog language. The UVM provides a common framework for developing verification environments, however using UVM requires manual coding, which can be time consuming and laborious for engineers. To facilitate this process, the building program 13 uses graphical representations of test scenarios that are associated with source code. For example, instead of a user manually writing the source code for a certain test sequence, the building program 13 enables the user to drag and drop graphical modules into the flow chart 38 that represent the source code for the test sequence. This can serve to essentially “copy and paste” the source code for the sequence into a file that the graphical sequence builder can use to ultimately generate the source code making up the test scenario sequence.

A flow control program 14 helps design and organize the flow between the graphical event modules of the flow chart 38. In response to receiving an “add logic” signal from the user interface 20, the flow control program 14 displays flow logic operators in the graphical environment in relation to the flow chart 38 via the user interface 20. For example, a user may click on a logic operator 45 of the drop-down menu 43 (shown in FIG. 6) with the mouse cursor arrow icon 39 on the user interface 20 to generate the add logic signal. The flow control program 14 executes the add logic signal to access an array of flow logic operators from the memory 70, and the flow logic operators are associated with source code that executes to simulate flow logic of the test scenario. In a manner similar to that for the event modules, each flow logic operator can be displayed as a graphic on the user interface 20. The flow control program 14 connects the graphical event modules in the flow chart 38 with at least one graphical flow logic operator from the array of flow logic operators.

Some examples of the graphical sequence builder also include a code generating program 15. The CPU 10 executes the code generating program 15 to generate test code based on the source code associated with the graphical event modules of the flow chart and the flow control modules. For example, the code generating program 15 stitches together the source code in such a manner that retains the sequence of the source code associated with each module in the graphical environment. The code generated by the code generating program 15 can then be used to simulate the test scenario on an integrated circuit.

As noted above, some examples of the graphical sequence builder include a navigation program 140. The CPU 10 can execute the navigation program 140 to allow a user to manipulate, edit, and modify the display of a user interface 20. The navigation program 140 can control the display of the source code associated with the graphical environment via the user interface 20 in response to receiving a command, such as a display control input signal generated by a user via the user interface 20.

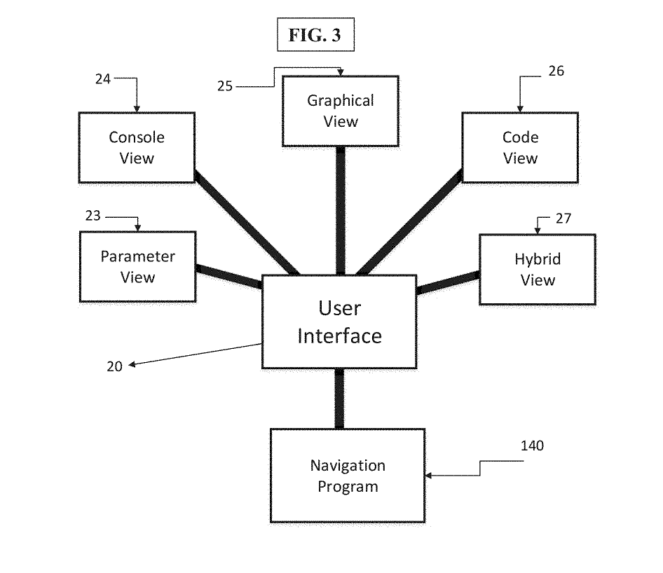

The block diagram example of FIG. 3 shows the display views associated with the navigation program 140. For instance, a user can toggle back and forth between a graphical view 25 that displays the graphical environment on the user interface 20, a parameter view 23 that displays the parameters associated with the graphical test scenario displayed in the graphical environment on the user interface 20, a console view 24 that displays manual command line environment prompts on the user interface 20, and a code view 26 that displays the source code associated with the graphical environment. In some embodiments, the user can also elect a hybrid view 27 that can display a combination of views.

An example screenshot of a hybrid view 27 consisting of four views displayed on a user interface 20 is shown in FIG. 4. Specifically, the CPU 10 may execute a parameter viewing program that displays the test scenario parameters in a parameter view 23 in response to receiving a view parameter signal from the user interface 20, as shown in the bottom right window. Test scenario parameters are specifications associated with test scenarios that may be defined by a user. For example, one parameter is a sequence name, wherein the user can name the test sequence. Another example of parameter is a sequence description, wherein the user can type a description of the test sequence. For instance, a user opens the parameter view window on the user interface 20 with the mouse cursor arrow icon 39 that is received by the navigation program 140, initiating the parameter view program. The parameter viewing program operates to display various test scenario parameters in the parameter view 23 associated with the selected components of the flow chart 38 in response to receiving a view parameter signal.

FIG. 4 also shows the console view 24 in the bottom left window, wherein the user can type instructions on a command line to be executed by the CPU 10. For example, a user can type commands at the command line to navigate between directories, view storage space, view and change read/write/execution permissions. The graphical view 25 is displayed in the upper right window with an example graphical test scenario shown. The graphical test scenario is a flow chart assembled by the user via the various programs. The navigation program 140 is configured to display a zoomed in view of the flow chart in the graphical view 25 in response to receiving a zoom in signal from the user interface 20, wherein the zoomed in view displays the flow chart in more detail. For example, a user moves and clicks a magnifying glass icon (e.g., with a “+” sign in the magnifying glass icon) via the navigation program 140, sending a zoom in signal to the user interface 20 to show a zoomed-in view of the flow chart. Similarly, the navigation program 140 can display a zoomed out view of the flow chart 38 in the graphical view 25 in response to receiving a zoom out signal (e.g., a magnifying glass icon with a “−” sign) from the user interface 20, thus displaying a less detailed view of the flow chart 38 than the zoomed in or default view.

The navigation program 140 can also operate to display a panned view of the flow chart 38 in response to receiving a pan signal from the user interface 20, wherein the panned view can display aspects of the flow chart 38 which are horizontally wider than the graphical view 25 window on the user interface 20. For example, a user executes the navigation program 140 by clicking and sliding a slide bar to the right or to the left to display aspects of the flow chart 38 which are horizontally wider than the graphical view 25 window on the user interface 20.

The flow chart 38 can also be configured to display a fit to screen view in response to receiving a fit to screen signal from the user interface 20, such that the graphical view 25 window is expanded to occupy the entire display on the user interface 20. For example, the user clicks on a box icon 27 in the upper-right corner of any of the windows or the hybrid view window on the user interface 20 sending a fit to screen signal that is received by the navigation program 140 that executes to expand any of the windows or the hybrid view window to fill the entire screen on the user interface 20.

A code view 26 window is displayed in the upper left window of FIG. 4. In response to receiving a view code signal from the user interface 20, the code view 26 window displays the source code associated with at least the source code associated with flow chart 38 components. For example, a user opens the code view window on the user interface 20 with the mouse cursor arrow icon 39 that is received by the navigation program 140, initiating the code view program.

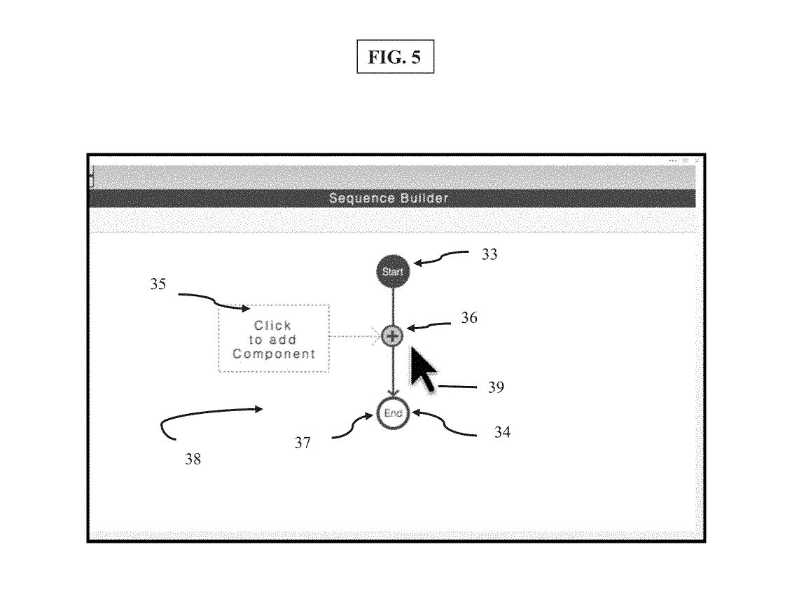

FIG. 5 shows an example screenshot of a graphical environment of a test scenario to be performed on an integrated circuit. The flow chart in the graphical environment displays a graphical start node 33 and a graphical end node 34, representing the start and end of the test scenario, respectively. The building program 13 and the flow control program 14 can be used to add graphical event modules and graphical flow control operators between the start and end nodes via a “click area” dot graphic 35 (e.g., circular icon with a “+” sign within) associated with a “click to add component” graphic 37 (e.g., dotted-line, rectangular-shaped icon), visible over the graphical connection arrow 36 in the flow chart 38. The click area dot graphic 35 can enlarge, animate, change in color, or otherwise highlight itself when a user hovers a mouse cursor over it. In an example of operation, a user can click the click dot area graphic 35 with the mouse cursor arrow icon 39 that is received by the navigation program 140, prompting the building program 13 to display a graphical event module associated with source code.

In FIG. 6, a user can select, via the user interface 20 operating the navigation program 140, the drop-down menu 43 to add one or more event modules (or “action blocks”) 44 or flow logic operators (or “flow control”) 45 to the flow chart 38. The user can also remove modules by right clicking and selecting “delete,” however a module cannot be changed to a different type when added. Each event module 44 and flow logic operator 45 is associated with source code. The graphical sequence builder can be configured so that the graphical start node 33 and the graphical end node 34 automatically appear in the graphical environment by default whenever a new test scenario is created, and cannot be dragged or removed. Typically, the graphical start node 33 and graphical end node 34 will appear in the flow chart and the building program 13 will be configured so that all other components are added there between. In some examples, the program may prohibit adding components before the start node 33 or the end node 34, however, in some examples, the program may be modified to allow alternative flow chart configurations and formats.

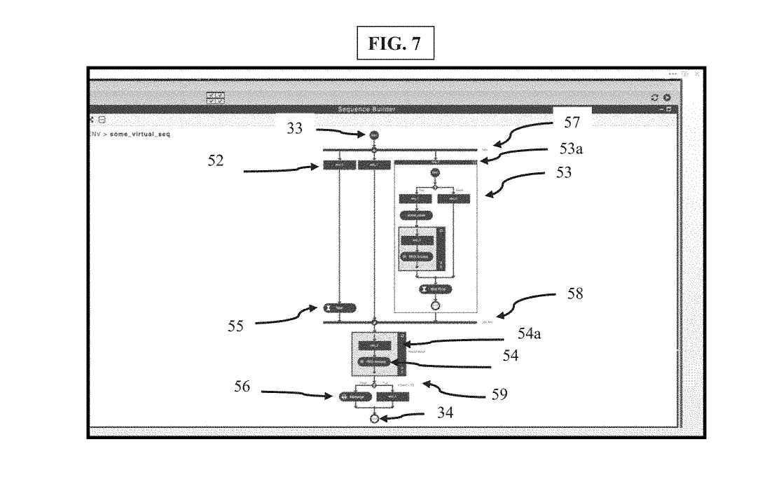

When a user selects an event module 44 or a flow control module 45 the building program 13 and/or the flow control program 14 will display the module as a graphic in the graphical environment of the graphical view window 25. FIG. 7 shows an example of a user-assembled test scenario, forming a flow chart that displays event modules and flow controls selected from the drop-down menu 43 of FIG. 6. The action components of the event module array 44 of the drop-down menu 43 include a sequence block, a UVM_Message, a register access, a wait event, a wait time, and a custom code block, which will be expounded upon below.

In FIG. 7 the sequence block graphical event modules 52 are displayed as solid rectangles, and represent source code of the building program 13 associated with test events. The graphical sequence block 52 has an instance name (e.g., seq_0, seq_1, seq_2, seq_3, and seq_4) which, typically, is set by the user by clicking on the graphical sequence block 52 with the mouse cursor icon 39 and typing an instance name and type to be displayed on the graphical sequence blocks 52. Hovering over a graphical sequence block (e.g., the user placing the mouse cursor icon 39 on top of the graphical sequence block displayed on the user interface 20) will display an “expand” icon to display the contents of the graphical sequence block of the current test scenario. For example, the graphical sequence block, seq_2, is enlarged, such that this single graphical sequence block displays a virtual nested sequence 53. The expanded nested sequence 53 is displayed in a wrapper. The nested sequence 53 can be collapsed, for example, by a user clicking from the “collapse” icon 53a on the wrapper title with the mouse cursor arrow icon 39. A user may expand or collapse all graphical sequence blocks (including multiple nesting) via the navigation program 140 from the toggle button on the flow chart toolbar.

UVM_Messages facilitate communication between the building program 13 and the user interface 20. The user can set one message per UVM_Message graphical event module 56, and may set the severity to one of a variety of severity indicator levels. These levels can include, for example, one or more of the following: UVM_INFO, UVM_WARNING, UVM_ERROR, UVM_FATAL to indicate, for example, information about the sequence, a warning of a potential issue in the sequence, a run-time or other type of error in the sequence, or a fatal issue with the sequence. If UVM_INFO is selected, then the user may set the message “verbosity” to one of the following: UVM_NONE, UVM_LOW, UVM_MEDIUM, UVM_HIGH, UVM_FULL, and UVM_DEBUG. Variables can be added for printing inside the message.

In a computer, a register is a small set of data holding places that are part of the CPU. The register may hold a storage address, source code, a bit sequence or individual characters. The graphical register access module 54 represents the source code associated with accessing the CPU registers and is used for read and write transaction to the register files. The register access module 54 is a software model of the registers of an electronic circuit device, or chip. The model holds the expected value of each of the device's registers at any given time. During simulation, the actual registers value of the device is read and checked versus the register model. In addition, there is a register access module that performs read and write operation to the registers. The graphical register access module 54 has several “register access types”, such as write, read, and poll, that are visible in a pop-up upon clicking the graphic. Until the register access type and register access are defined, the component (e.g., a graphical event module or graphical flow control module) is not validated, and the user may not select another component, or leave the test scenario.

Another useful event action component of the event module array 44 of the drop-down menu 43 is a wait event. The graphical wait event module 55 is associated with source code of the building program 13 relaying to the test sequence to wait a specified time until a specific event occurs in the test scenario via a “wait for” command in the source code, which may include clock cycle, (e.g., in terms of nanoseconds and picoseconds). The exact time for the program to pause is selected from the wait time event module from the action blocks 44 of the drop-down menu 43.

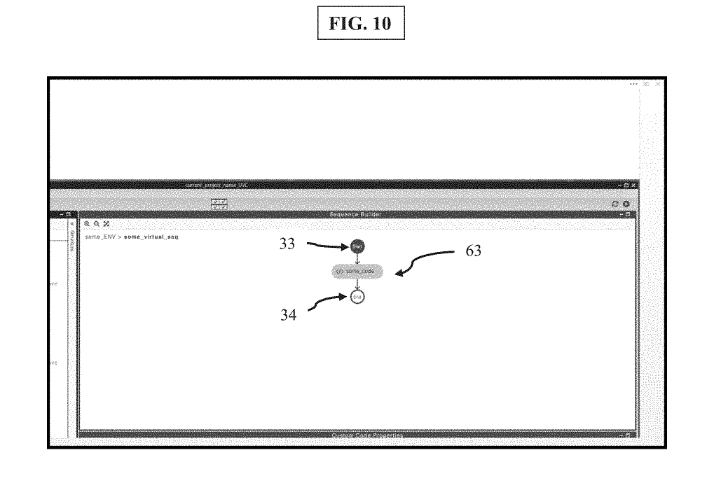

A user can write and/ or modify code associated with the test sequence by selecting the custom code block of the drop-down menu 43. FIG. 10 shows a custom code graphic event module 63 on the user interface 20, wherein a user can insert any computer code not available in other components. A code editor opens inside of the custom code graphic event module pane 63, and can be dragged and dropped, duplicated, and deleted like any other graphic event module. For example, a user may devise their own source code for a test event and click on the custom code graphic event module pane 63 with the mouse cursor arrow icon 39 and type their own test event code. In this manner, a user can create and/ or modify event modules or flow control modules by adding, deleting, or otherwise changing the source code associated with the modules.

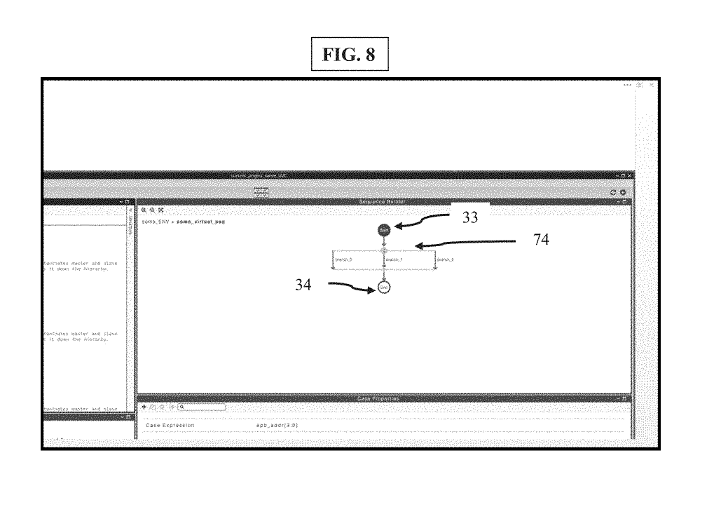

FIG. 7 also shows graphical flow logic operators from the drop-down menu 43. These flow logic operators or logic nodes dictate the flow of the test sequence based on the existence or lack therof of certain conditions. These logic nodes include at least one of an If node, a Case node, a Fork Join node, a For Loop node, and a While Loop node. The graphical If node 59 is used to select if the sequence flows in one of two possible directions or “branches” 74a (displayed as “True” or “False” branches in FIG. 7 and FIG. 8). The sequence can never flow in both directions using the If node 59. The user cannot add or remove branches from an If node. A user may also leave one branch with no action block, however having both branches without action block components is valid but meaningless.

FIG. 8 shows and example of a Case node 74, which is generally used to select if the sequence flows in one of multiple possible branches 74a. The sequence can never flow in more than one direction using a Case node. The user can add or remove the branches 74a from the case node. Selecting delete will result in a pop-up confirmation alert. A user may also leave a branch with no action (equal to having no graphical components between the start node 33 and end node 34).

A Fork node is created by default with two threads. For example, FIG. 7 shows a graphical Fork node 57, followed by assembled componentry, such as the sequence block 52 and the virtual nested sequence 53, connected to the graphical type “Join Any” node 58 associated with source code to combine any of the test events between Fork node threads. A Fork node of type Fork Join None is associated with source code that will not combine any of the threads.

The user may add or remove threads. Removing a thread with a component defined on it will invoke a confirmation pop-up. The user may define a name for each thread to be displayed on the flow chart 38. Hovering over a thread will highlight it in the flow chart 38.

FIG. 7 also shows an example of a graphical For Loop node 54a, representing the For Loop flow control module associated with source code to cycle over a number of different test events in a sequence block. The For Loop 54a creates an empty wrapper, and a user is required to add components inside the wrapper; for example, the graphical register access 54. For example, an empty For Loop may be valid but meaningless. The number of loops defined is displayed in the diagram (e.g., “x 5”, or a loop of five operations is shown in the For Loop 54a). Any number of For Loop nodes can be nested within an existing For Loop node.

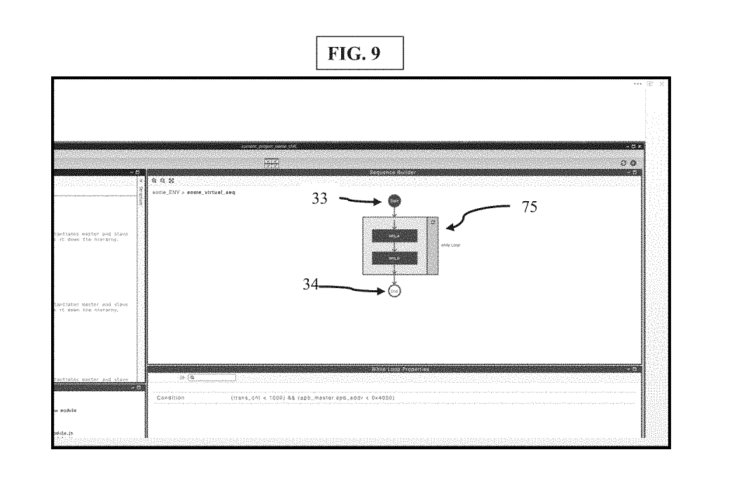

FIG. 9 shows an example of a graphical While Loop node 75, which is similar to the For Loop node 54a in that iterations of operations are executed repeatedly, with the distinction being that the While Loop logic allows code to be executed based on a specified condition or conditions to be met. In operation, the While Loop is a repeating “if” statement, such that if a condition is met, then the proceeding source code is executed, else the While Loop is exited.

Certain embodiments of the disclosure also present methods for generating test code to be used to simulate testing on an integrated circuit. The methods can be carried out by a computer, or a computer processor executing the programs of FIG. 2. The computer carrying out the method can have a memory, a processor, and a user interface. In some examples, the method can be carried out by the computer and/or the computer processor executing the programs described above.

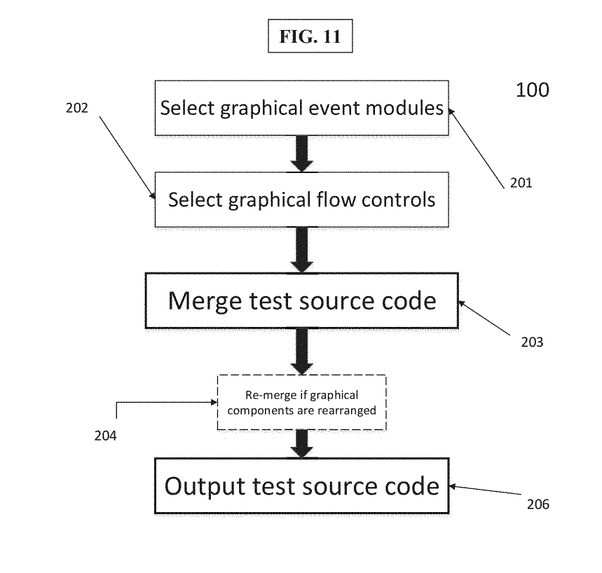

FIG. 11 is a flow diagram of an exemplary method 100 for building a graphical test scenario with the graphical sequence builder. The method 100 includes generating a graphical flow chart representation for display on a user interface in response to receiving add event graphic signals and add logic graphic signals from a user interface. The add event graphic signal accesses an array of event modules on a memory. The event modules in the array are associated with source code that executes to simulate a test event as part of a test scenario.

According to one embodiment of the method 100, a user selects 201 an event module from the action blocks from a graphical drop-down menu and the event module is displayed as a graphical event module in a flow chart. The flow chart may display, by default, a start node and an end node associated with source code to start and end the test scenario, respectively. Two or more graphical event modules may be combined into a single nested graphical event module in response to receiving a signal from the user interface.

In the same manner as the add event graphic signal, the add logic signal also accesses an array of flow logic operators on a memory. The flow logic operators in the array are associated with source code that executes to simulate flow logic as part of the test scenario. According to the method 100, a user can select 202 a flow logic operator from the flow controls from a graphical drop-down menu and the flow control module is displayed as a graphical flow control module in the flow chart. At least one graphical flow logic operator (associated with a flow logic operator from the array of flow logic operators) connects graphical event modules in the flow chart in order to build a test scenario.

The source code associated with each graphical event module and each graphical flow logic operator of the test scenario is then merged 203 to generate a test code, wherein the merging of the graphical event module source code with the flow logic operator source code maintains the sequence of the graphical event module source code and the flow logic operator source code based on the flow chart. This merging 203 is dictated by the flow logic. Furthermore, the user can rearrange the graphical event modules by dragging and dropping modules within the flow chart. The method 100 can then re-merged 204 the source code to maintain the new sequence of the graphical event module source code and the flow logic operator source code. The re-merging 204 of the source code based on the rearranging of the componentry (i.e., the graphical event modules and flow logic operators), may also be dictated by the flow logic operator.

In one embodiment, the code viewing window displays the source code associated with selected objects in the flow chart in response to receiving a view code signal from the user interface directed to at least one selected object in the flow chart. In another embodiment, a parameter viewing window on the user interface, the parameter viewing window displays test scenario parameters associated with selected objects in the flow chart in response to receiving a view parameter signal directed from the user interface directed to at least one selected object in the flow chart, wherein the test scenario parameters includes at least one of a sequence name, a sequence description, a sequence variable, and a sequence condition.

In some examples, the generated source code associated with the graphical sequence test builder is written to a file, saved, and then outputted 205. The outputted test scenario file can be compilable, thereby alleviating a need for the end user to “generate” action. So configured, the graphical sequence builder outputs 205 a test scenario to be run on an integrated circuit without involving manual coding or de-bugging.

This disclosure describes preferred embodiments and examples of the present technology. It should be recognized that a wide variety of modifications, alterations, and combinations can be made with respect to the above described embodiments without departing from the scope of the invention as set forth in the claims, and that such modifications, alterations, and combinations are to be viewed as being within the ambit of the inventive concept. It should also be understood that features of one embodiment may be combined with features of other embodiments to provide yet other embodiments as desired. Further, all reference discussed in this document are hereby incorporated by reference in their entirety.

what is claimed is:

1. A computer processor configured to generate test code based on a graphical representation of a test scenario performed on an integrated circuit, the computer processor being in communication with a user interface and a memory, the processor configured to execute:
a building program that builds a flow chart for display on the user interface, the building program configured to, in response to receiving an add event signal from the user interface:
access an array of event modules from the memory, each event module in the array being associated with source code that executes to simulate a test event as part of the test scenario; and
display a graphical event module in the flow chart, each event module graphic being associated with an event module from the array of event modules;
a flow control program that displays flow logic operators in relation to the flow chart on the user interface, the flow control program configured to, in response to receiving an add logic signal from the user interface:
accesses an array of flow logic operators from the memory, each flow logic operator being associated with source code that executes to simulate flow logic of the test scenario; and
connect graphical event modules in the flow chart with at least one graphical flow logic operator, each graphical flow logic operator associated with a flow logic operator from the array of flow logic operators; and
a code generating program that generates test code, the test code executing to simulate the test scenario performed on the integrated circuit upon,
wherein the flow chart having at least one includes at least one graphical event module and at least one graphical flow logic operator connected to each graphical event module and graphically represents the test scenario, and
wherein the test code generated by the code generating program is based at least in part on the source code associated with each graphical event module and each graphical flow logic operator in the flow chart.

2. The computer processor of claim 1, wherein the flow chart displays a graphical start node that represent the start of the test scenario and a graphical end node that represents the end of the test scenario, and wherein the building program and the flow control program are configured to add graphical event modules and graphical flow control operators between the start nodes and the end nodes.

3. The computer processor of claim 1, wherein at least some of the flow logic operators of the flow logic array represent logic nodes that direct the flow of the test sequence among the graphical event modules of the flow chart.

4. The computer processor of claim 1, wherein the building program is configured to combine two or more of a graphical event module and a graphical flow logic operator into a single nested graphical event module that represents a sub sequence of the test sequence.

5. The computer processor of claim 1, wherein the add event signal includes operating a drag and drop function via the user interface.

6. The computer processor of claim 1, wherein the add event signal includes selecting an icon via the user interface.

7. The computer processor of claim 1, further configured to execute a code viewing program that displays source code in a code viewing window on the user interface in response to receiving a view code signal from the user interface, the displayed source code comprising at least the source code associated with flow chart objects associated with the view code signal.

8. The computer processor of claim 1, further configured to execute a parameter viewing program that displays test scenario parameters in a window on the user interface in response to receiving a view parameter signal from the user interface.

9. The computer processor of claim 8, wherein the parameter viewing program is configured to display test scenario parameters associated with selected components of the flow chart in response to receiving a view parameter signal associated with the selected components of the flow chart.

10. The computer processor of claim 9, wherein the test scenario parameters includes at least one of a sequence name, a sequence description, a sequence variable, and a sequence condition.

11. The computer processor of claim 1, further configured to execute a navigation program that modifies the display on the user interface in response to receiving a navigation signal from the user interface.

12. A method of generating test code that executes to simulate a test scenario on an integrated circuit, the method comprising;
generating a graphical flow chart representation of the test simulation for display on a user interface, the generating comprising;
in response to receiving an add event graphic signal from a user interface, accessing an array of event modules on a memory with a computer processor, each event module in the array being associated with source code that executes to simulate a test event as part of the test scenario; and displaying a graphical event module in the flow chart, each event module graphic being associated with an event module from the array of event modules; and
in response to receiving an add logic graphic signal from the user interface, accessing an array of flow logic operators on a memory with a computer processor, each flow logic operator being associated with source code that executes to simulate flow logic of the test scenario; and connecting the graphical event modules in the flow chart with at least one graphical flow logic operator, each graphical flow logic operator associated with a flow logic operator from the array of flow logic operators; and
merging the source code associated with the graphical event modules and the graphical flow control operators in the flow chart to generate a test code,
wherein the merging of the graphical event module source code with the flow logic operator source code maintains a sequence of the graphical event module source code and the flow logic operator source code based on the flow chart.

13. The method of claim 12, further comprising displaying a start node on the flow chart, the start node associated with source code that executes to simulate the initiation of the test scenario.

14. The method of claim 12, further comprising displaying an end node on the flow chart, the end node associated with source code that executes to simulate the end of the test scenario.

15. The method of claim 12, wherein the merging of the source code is merged in an order that is dictated by the flow logic.

16. The method of claim 12, wherein the graphical event modules and the flow logic operators are added to the flow chart in response to receiving a signal from the user interface corresponding to a user selecting an object from a graphical drop-down menu on the user interface.

17. The method of claim 14, wherein upon rearranging of the componentry (i.e., the graphical event modules and flow logic operators), the merging of the source code is merged in an order that is dictated by the flow logic operator.

18. The method of claim 12, wherein two or more graphical event modules are combined into a single nested graphical event module in response to receiving a signal from the user interface associated with selected graphical event modules dragged and dropped into a graphical event module in the flow chart.

19. The method of claim 12, further comprising displaying on the user interface a code viewing window interface, the code viewing window displaying source code associated with selected objects in the flow chart in response to receiving a view code signal from the user interface directed to at least one selected object in the flow chart.

20. The method of claim 12, further comprising displaying a parameter viewing window on the user interface, the parameter viewing window displaying source test scenario parameters associated with selected objects in the flow chart in response to receiving a view parameter signal directed from the user interface directed to at least one selected object in the flow chart.
